(19) United States
(12) Patent Application Publication
(10) Pub. No.: US 2026/0092166 A1
(43) Pub. Date: Apr. 2, 2026

(54) A PLURALITY OF MICROCAPSULES AND USE THEREOF IN POLYMERS

(71) Applicant: CALYXIA SAS, Bonneuil-sur-Marne (FR)

(72) Inventors: Benoit THIEBAUT, Lyon (FR); Karima OUHENIA, Neuilly sur Marne (FR); Laura KLEBINDER, Thiais (FR); Arthur ZARROUKI, Paris (FR)

(73) Assignee: CALYXIA SAS, Bonneuil-sur-Marne (FR)

(21) Appl. No.: 19/140,577

(22) PCT Filed: Dec. 20, 2023
(86) PCT No.: PCT/EP2023/086954

§ 371 Date: Jun. 18, 2025

(30) Foreign Application Priority Data
Dec. 20, 2022 (FR) 2214023

(51) Int. Cl. C08K 9/10; B01J 13/16; C08L 63/00

(52) U.S. Cl. CPC C08K 9/10; B01J 13/16; C08L 63/00; C08L 2203/30

(57) ABSTRACT

A plurality of microcapsules having a cross-linked polymeric shell encapsulating an active ingredient, wherein the crosslinked polymeric shell comprises or consists of at least one polymer selected from aliphatic epoxidized poly acrylates, e.g. soy bean oil acrylates, bisphenol A based epoxy acrylates, glyceryl propoxy triacrylates, difunctional polyester acrylate oligomers, aliphatic polyester based urethane dimethacrylates or diacrylates and amine modified polyether acrylates. A plurality of microcapsules having a mechanical resistance such that when a dispersion of the plurality of microcapsules in an inert medium is submitted to a shear stress of equal to or greater than 3 kPa at a temperature of about 20° C. the rate of broken capsules observed by microscopy after submitting said dispersion to said shear stress for 10 minutes is less than 10%.

The present patent application claims priority to French Provisional Patent Application FR2214023, filed on Dec. 20^{th}, 2022, the entire contents of which is incorporated by reference into the present application for all purposes.

The present invention concerns a plurality of microcapsules which is mechanically resistant and useful in particular for improving the processing and the properties of polymers. The invention also concerns the use of the plurality of microcapsules in polymer processing, premixes comprising a polymer and the plurality of microcapsules and polymer compositions comprising the plurality of microcapsules.

The encapsulation of active ingredients has been developed as a technical option to protect such active ingredients from undesired and premature interactions with other components of formulations or reaction mixtures. The encapsulation is useful in particular to provide formulations, e.g. cosmetic, pharmaceutical and agricultural formulations having, an improved efficiency of use of the active ingredients and reaction mixtures, for example polymerization mixtures or polymer processing mixtures, which allow for improved processes and final products due to a better controlled use of active ingredients such as e.g.: catalysts. WO-A-2018/172431 in the name of the applicant discloses a series of microcapsules having a polymeric shell with a pore size less than 1 nm which are generally suitable for such purpose.

EP-A-2360221 relates to a thermally expandable microcapsule, which comprises: a shell made of a polymer; and a volatile expansion agent as a core agent encapsulated in the shell, the storage elastic modulus (E′) of the shell at a temperature of 200° C. and a frequency of 10 Hz being 1×10 N/m or more, the storage elastic modulus (E′) of the shell at a temperature of 250° C. and a frequency of 10 Hz being 1×10 N/m or more, and a maximum displacement amount measured by thermomechanical analysis being 300 μm or more. The elastic modulus is not measured on the capsules but on a test piece having a thickness of 0.2 mm (200 μm) which is not a suitable wall thickness for microcapsules capable of delivering an active ingredient and even exceeds the diameter of certain microcapsules.

The present invention now makes available still improved microcapsules which are particularly advantageous in terms of mechanical stability, enabling in particular their advantageous use in polymer processing processes which may involve high shear stress.

In a first aspect, the invention consequently concerns a plurality of microcapsules having a cross-linked polymeric shell encapsulating an active ingredient, wherein the crosslinked polymeric shell comprises or consists of at least one polymer selected from aliphatic epoxidized poly acrylates, e.g. soy bean oil acrylates, bisphenol A based epoxy acrylates, glyceryl propoxy triacrylates, difunctional polyester acrylate oligomers, aliphatic polyester based urethane dimethacrylates or diacrylates and amine modified polyether acrylates.

In a first embodiment of the plurality of microcapsules according to the first aspect of the invention, the crosslinked polymeric shell comprises or consists of at least one polymer selected from aliphatic epoxidized poly acrylates, for example, vegetable epoxidized oil acrylates particularly soy bean oil acrylates.

In a second embodiment of the plurality of microcapsules according to the first aspect of the invention, the crosslinked polymeric shell comprises or consists of at least one polymer selected from bisphenol A based epoxy acrylates. Examples of suitable polymers according to this embodiment are selected, for example, from polymers of 4,4′-isopropylidenediphenol with 1-chloro-2,3-epoxypropane polypropylene glycol monoacrylate and succinic anhydride; polymers of 2-propenoic acid, 2-hydroxyethyl ester, with (chloromethyl)oxirane, 1,3-isobenofurandione 4,4′-(1-methylethylidene)bis[phenol]and 2-oxepanone and polymers of 4,4′-(1-methylethylidene)bis phenol with (chloromethyl)oxirane, dodecanoate 2-propenoate.

In a third embodiment of the plurality of microcapsules according to the first aspect of the invention the crosslinked polymeric shell suitably comprises or consists of at least one polymer selected from glyceryl propoxytriacrylates.

In a fourth embodiment of the plurality of microcapsules according to the first aspect of the invention, the crosslinked polymeric shell suitably comprises or consists of at least one polymer selected from difunctional polyester acrylate oligomers. Examples of suitable polymers according to this embodiment are selected, for example, from polymers of propylidynetrimethanol, ethoxylated esters with acrylic acid and polymers of 2-[[2,2-bis[[(1-oxoallyl)methyl]butoxymethyl]-2-ethyl-1,3-propandyile diacrylate.

In a fifth embodiment of the plurality of microcapsules according to the first aspect of the invention, the crosslinked polymeric shell suitably comprises or consists of at least one polymer selected from aliphatic polyester based urethane dimethacrylates or diacrylates. Examples of suitable polymers according to this embodiment are selected, for example, from polymers of 2-propenoic acid, 2-hydroxyethyl ester with 1,1-methylenebis[4-isocyanatocyclohexane]and α,60 -1,2,3-propanetriyltris[w-hydroxypoly[oxy(methyl-1,2-ethanediyl]; polymers of the reaction product of 7,7,9-trimethyl-3,14-dioxa-4,13-dioxo-5,12-diazahexadecan-1,16-diyl-prop-2-enoate with 7,9,9-trimethyl-3,14-dioxa-4,13-dioxo-5,12-diazahexadecane-1,16-diyl-prop-2-enoate and polymers of 7,7,9-trimethyl-4,13-dioxo-3,14-dioxa-5,12-diazahexadecane-1,16-diyl bis-methacrylate.

In a sixth embodiment of the plurality of microcapsules according to the first aspect of the invention, the crosslinked polymeric shell suitably comprises or consists of at least one polymer selected from amine modified polyether acrylates. Examples of suitable polymers according to this embodiment are selected, for example, from polymers of oligomers of 2-amino-ethanol, with α-hydro-ω-[(1-oxo-2-propenyl)oxy]poly(oxy-1,2-ethanediyl) ether with 2-ethyl-2-(hydroxymethyl)-1,3-propanediol.

In one particular aspect of the first aspect of the invention the crosslinked polymeric shell comprises from 50% per weight to 80% per weight relative to the total weight of the crosslinked polymeric shell of said at least one polymer.

In a second aspect, the invention concerns a plurality of microcapsules having across-linked polymeric shell, wherein said plurality of microcapsules has a mechanical resistance such that when a dispersion of the plurality of microcapsules in an inert medium is submitted to a shear stress of equal to or greater than 3 kPa at a temperature of about 20° C., the rate of broken capsules observed by microscopy after submitting said dispersion to said shear stress for 10 minutes is less than 10%. In a preferred aspect, the rate of broken capsules is equal to or less than 5%. The rate of broken capsules may be about 0% but is usually greater than 0%, for example equal to or greater than 1%.

Unless stated to the contrary, the following description applies to both the first and the second aspect of the invention.

It has been found that the plurality of microcapsules according to the invention remains substantially intact under high mechanical stress conditions and is thereby particularly advantageous e.g; for targeted release of active ingredients. The plurality of microcapsules according to the invention has also particularly advantageous storage and transportation properties as breakage of microcapsules and associated degradation of the plurality of microcapsules can be substantially avoided. A further advantage of said plurality of microcapsules is the ability to survive and thereby protect active ingredients over the course of industrial processing and forming of polymers, by techniques such as e.g. injection molding and/or extrusion molding. The microcapsules are then able to release any needed active ingredients upon a purposive exposure to a stimulus, such as e.g. a change in temperature, without loss of the reactive component before said exposure. The plurality of microcapsules according to the invention may have high resistance whan exposed to a variety of types of mechanical stresses such as e.g. shear stress and compressive stress.

The plurality of microcapsules according to the invention may have a high mechanical resistance, also at higher shear stress. For example, the shear stress may be equal to or greater than 6 kPa, in particular equal to or greater than 9 kPa. The shear stress generally does not exceed 1 MPa, it is in particular equal to or lower than 30 kPa. The shear stress can reach up to 50 MPa in industrial processing of resins containing capsules. Therefore the shear stress in a three-roll mill system can also be adjusted to approximate these conditions by controlling the viscosity of the medium, the gap between the mills and the rotation speed, as will be known to a person skilled in the art. Under these conditions the plurality of capsules demonstrate a high degree of intactness as is outlined below.

The mechanical resistance of the plurality of microcapsules is preferably measured by method (1) described below.

The temperature during the measurement is kept at about 20° C. “About 20° C.” is understood to denote in particular that the temperature is kept between 17 and 23° C., in particular between 18 and 22° C. It has been observed that variations in this temperature range during the measurement have no impact on the rate of broken microcapsules.

For the purpose of the present invention, «broken microcapsule» means a microcapsule whose shell has a visible perforation of its shell when examined with an optical microscope equipped with a 100× objective. By way of example, a DMi8 microscope (from Leica) operating in transmission light mode equipped with a HCX Plan Apo 100×/1.4-0.7 objective can be used to evaluate said collection of capsules.

For the purpose of the present invention, «inert medium» denotes a, generally liquid, medium which displays no chemical reactivity towards the cross-linked polymeric shell under the conditions of the determination of the mechanical resistance, including the observation by microscopy. The inert medium has usually an optical transparency of greater than 80% as defined by for instance ASTM standard D 1746.

The inert medium has preferably a viscosity of equal to or greater than 400 cPa-s to equal to or lower than 1500 cPa-s at 1000 s⁻¹ to 2000 s⁻¹. In particular the viscosity of the inert medium displays negligible variation i.e. <10%, preferably <5%, most preferably <2% in a shear range of from 1000 s⁻¹ to 2000 s⁻¹.

One example of a suitable inert medium is a solution of carboxymethylcellulose in water. Another example of a suitable inert medium is selected from silicones.

For the purpose of the present invention, the term “mean diameter or average of the microcapsules” refers to the Dn50 diameter. Dn50 is the median of the number averaged size distribution of the microcapsules. The size distribution of the microcapsules, and thus the mean diameter of the microcapsules, may be measured by methods well known to the skilled person in the art, e.g. by a light scattering technique such as a Mastersizer 3000 equipped with a hydro SV measuring cell, or by image analysis of optical microscopy pictures, or by image analysis of electronic microscopy pictures.

For the purposes of the present invention, «monodisperse» is understood to denote with reference to a series of droplets or a series of capsules, that the standard deviation of the distribution of the diameter of said droplets or said capsules is less than 50%, in particular less than 25%, or less than 1 μm. For the purposes of the present invention, the diameter of said droplets or said capsules is determined by light scattering technique using a Mastersizer 3000 (Malvern Instruments) equipped with a Hydro SV measurement cell.

For the purpose of the present invention «plurality» refers to a significant number of microcapsules, for example a quantity of microcapsules obtained from a synthesis of microcapsules or a quantity of microcapsules suitable for application, in particular industrial application in the intended use of the microcapsules. For the purpose of determining the broken microcapsules of the series of microcapsules, a representative sample will be used as described below, comprising at least 50, preferably at least 100 microcapsules.

It has been observed that for a given set of conditions of shear, temperature and duration of shear, the nature of the inert medium and the concentration of the microcapsules in the dispersion have no measurable impact on the rate of broken capsules. However, typically, the concentration of microcapsules in the dispersion is from 10% by weight to 25% by weight relative to the total weight of the dispersion.

In another aspect of the invention, the mechanical properties of the plurality of microcapsules are measured by nanoindentation. Nanoindentation is a method by which an individual microcapsule is exposed to a compressive stress through the application of an indentor with either a Berkovich (pyramidal), flat punch indentor or a spherical indentor. In the present invention, by way of example, the Anton Paar NHT3 nanoindentor can be employed. A suitable way of carrying out the measurement by nano-indentation can be described as follows: A hard tip whose mechanical properties are known, frequently made of a very hard material like diamond, is pressed into a sample whose properties are unknown. The load placed on the indenter tip is increased as the tip penetrates further into the specimen until it reaches a user-defined value. At this point, the load may be held constant for a period or removed. An indenter with a geometry known for high precision (usually a Berkovich tip, which has a three-sided pyramid geometry) is employed. During the course of the instrumented indentation process, a record of the depth of penetration is made, and then the contact area between the indentor and the microcapsule is determined. While indenting, parameters such as load and depth of penetration can be measured using the capacitive sensors. A record of these values can be plotted on a graph to create a load-displacement curve, which is then used to extract mechanical properties of the material. The area of the residual indentation in the sample is measured through an optical or scanning electron microscope that is a standard component of a nanoindentation system, and the hardness, H, is defined as the maximum load, Pₘₐₓ, divided by the residual indentation area, A, as determined by an in-situ microscopic image analysis.

The rupture force, i.e. the force at which a large displacement of the indentor can be observed, is indicative of the force a capsule can withstand before rupture. Usually, the large displacement is evidenced by an inflection point in the force/displacement curve. Accordingly, another aspect of the present invention concerns a plurality of microcapsules having a mechanical resistance such that, the rupture force for said capsules is greater than 100 μN, preferably greater than 300 μN, but does generally not exceed 1000 μN. Said rupture force can be described more universally by a rupture stress, which is simply the rupture force divided by the surface area of the indentor. In the case of a flat punch indentor having a plate-like geometry with a diameter of 20 μm, and therefore an area of 314 μm², the rupture stress is greater than 0.5 MPa and preferably greater than 1 MPa, most preferably greater than 3 MPa. The diameter of the flat punch indentor is however usually chosen to be equal to or greater than the diameter of the microcapsule to analyse.

Alternatively, the rupture stress is more optimally calculated using the contact surface area between the surface of the indentor and the surface of the microcapsule. The contact area in the sense of the current invention can be determined using the principle of conservation of volume before rupture of the microcapsule. The microcapsules are observed under optical microscopy before being measured by nanoindentation. The diameter of the capsule is determined from the two dimensional images taken of the microcapsule to be investigated. The capsules are on average spherical before nanoindentation. Therefore the volume of the capsules in the plurality of microcapsules according to the invention is calculated as a sphere. The volume is conserved under compression, which induces a deformation into an ellipsoid. For the purpose of determining the rupture stress of the plurality of microcapsules according to the invention, the ellipsoid is considered as a rectangular cuboid whose volume is given by the formula V=z x A, wherein V is the volume, z is the height of the deformed capsule, determined as the difference between the undeformed capsules diameter d and the displacement h measured by the nanoindentor and A is the contact area. The volume of the rectangular cuboid is set as equal to the volume of the capsule prior to compression.

Therefore, the contact area A is simply the capsule volume divided by the capsule height z, given by the formula

$$A = ( 4 / 3 \times π \times {( d / 2 )}^{3} ) / z$$

The contact area at rupture is determined based on the z value at the point of non-linearity of the displacement curve of force versus displacement that is a standard measurement under nanoindentation.

In another aspect, the invention concerns a plurality of microcapsules having a diameter between 1 and 30 μm and having a mechanical resistance such that when said plurality of microcapsules is exposed to a force of 3000 μN, the percentage of broken capsules, determined by optical microscopy does not exceed 10%, preferably wherein the percentage of broken capsules is from greater than 0% to 5%, more preferably from greater than 0% to 1%.

In this aspect, the mechanical resistance is generally such that when said plurality of microcapsules is exposed to a compressive stress of 1 MPa, the percentage of broken capsules, determined by optical microscopy does not exceed 10%.

In still another aspect, the invention concerns a plurality of microcapsules having a diameter between 1 and 30 μm with a monodisperse size distribution and having a mechanical resistance such that when said plurality of microcapsules is exposed to a compressive stress of between 1 and 3 MPa, the percentage of broken capsules, determined by optical microscopy, as described above, does not exceed 10%, preferably does not exceed 5% and most preferably does not exceed 1%. The rate of broken capsules in this aspect may be about 0% but is usually greater than 0%.

In the plurality of microcapsules according to the invention, the microcapsules generally have an average diameter of equal to or greater than 1 μm, preferably equal to or greater than 3 μm. In the plurality of microcapsules according to the invention, the microcapsules generally have an average diameter of equal to or smaller than 30 μm, preferably equal to or smaller than 20 μm.

In the plurality of microcapsules according to the invention, the microcapsules generally have a shell thickness of equal to or greater than 0.1 μm, preferably equal to or greater than 0.2 μm. In the plurality of microcapsules according to the invention, the microcapsules generally have a shell thickness of equal to or smaller than 20 μm, preferably equal to or smaller than 8 μm. Shell thickness can also be denoted as wall thickness and refers to the thickness of the, generally solid, envelope of cross-linked polymer which encloses the inner space of a microcapsule.

In a first particular aspect of the plurality of microcapsules according to the invention, the microcapsules have an average diameter of 1 to 30 μm and a wall thickness from 0.1 to 20 μm.

The plurality of microcapsules according to the invention is often monodisperse.

In a second particular aspect of the plurality of microcapsules according to the invention, the microcapsules have mean diameter between 1 μm and 30 μm, the thickness of the solid enveloping shell is between 0.2 μm and 8 μm and the standard deviation of the distribution of the diameter of microcapsules is less than 50%, or less than 1 μm.

The plurality of microcapsules may have pores on the shell surface of the microcapsules which have an average diameter smaller than 1 nm, determined by BET surface analysis.

In a preferred aspect of the plurality of microcapsules according to the invention, the crosslinked polymeric shell is obtained by photopolymerization of a photopolymerizable composition having reactive groups. In this aspect, the conversion of reactive groups of the photopolymerizable composition is generally at least 80%, preferably at least 90%.

The conversion of reactive groups can be determined by the monitoring of the disap-pearance of one band representative of a functional group under FTIR, the absorption of IR bands being proportional to the amount of the functional group, therefore the reduction of peak height corresponds to the reduction of the amount of the functional group, further indicating successful polymerization. The standard method of doing this is comparison of the FTIR absorption of the emulsion before and after cross-linking, in particular by photopolymerization. For the purpose of the present invention this can be done using the method disclosed in Barszczewska-Rybarek, Materials 2019, 12(24), 4057. By way of example, the conversion of reactive groups of an acrylate over the course of radical polymerization can be observed as a function of the reduction in FTIR absorption of the signature spectrum thereof, which for acrylates falls between 2900 and 3000 μm wavelength.

The invention consequently also concerns a plurality of microcapsules having across-linked polymeric shell encapsulating an active ingredient, wherein the cross-linked polymeric shell has a degree of conversion determined by observation of the reduction of FTIR absorption of a characteristic FTIR absorption band of a cross-linkable precursor group of the cross-linked polymeric shell which is equal to or greater than 80%, preferably equal to or greater than 90%. Generally, this degree of conversion is lower than 100%, in particular equal to or lower than 95%. In the case wherein the cross-linking is carried out by photopolymerization, the degree of cross-linking corresponds to the degree of conversion of polymerizable groups.

According to the invention, in particular its first aspect, the cross-linkable precursor groups are preferably selected from acrylate and methacrylate.

Without wishing to be bound by any theory, it is believed that the degree of cross-linking confers advantages in terms of mechanical stability and retention capabilities of the microcapsules.

In a preferred aspect, the plurality of microcapsules characterized by its degree of cross-linking are in accordance with the plurality of microcapsules according to the invention described herein.

In the second aspect of the plurality of microcapsules according to the invention, the crosslinked polymeric shell often comprises or consists of at least one polymer selected from polyethers, polyesters, polyurethanes, polyureas, polyethylene glycols, polypropylene glycols, polyamides, polyacetals, polyimides, polyolefins, polysulfides, and polydimethylsiloxanes, said polymers bearing at least one reactive function selected from the group consisting of acrylate; methacrylate; vinyl ether; N-vinyl ether; mercaptoester; thiolene; siloxane; epoxy; oxetane; urethane; isocyanate; and peroxide.

The term “crosslinking agent” is used to refer to a compound bearing at least two reactive functional groups that are capable of crosslinking a monomer or a polymer, or a mixture of monomers or polymers, during its polymerisation.

Examples of specific polymers which can be used to produce the cross-linked shell in the second aspect of the microcapsules according to the invention include, but are not limited to, the following polymers: poly(2-(1-naphthyloxy)-ethyl acrylate), poly(2-(2-naphthyloxy)-ethyl acrylate), poly(2-(2-naphthyloxy)-ethyl methacrylate), polysorbitol dimethacrylate, polyacrylamide, poly((2-(1-naphthyloxy) ethanol), poly(2-(2-naphthyloxy) ethanol), poly(1-chloro-2),3-epoxypropane),poly(n-butyl isocyanate), poly(N-vinyl carbazole), poly(N-vinyl pyrrolidone), poly(p20benzamide), poly(p-chlorostyrene), poly(p-methyl styrene) poly(p-phenylene oxide), poly(p-phenylenesulfide), poly(N-(methacryloxyethyl)-succinimide), polybenz-imidazole,polybutadiene, polybutylene terephthalate, polychloral, polychlorinated tri-fluoroethylene,polyether imide, polyether ketone, polyether sulfone, polyhydri-dosilsesquioxane, poly(m-phenyleneisophthalamide), poly(methyl-2-acrylamido-2-methoxyacetate), poly(2-acrylamido-25 2-methylpropanesulfonic acid), poly-mono-butyl maleate, polybutyl methacrylate,poly(N-tertbutylmethacrylamide),poly(N-butylmethacrylamide), polycyclohexyl-methacrylamide, poly(N-xylene bisacrylamide-2,3-dimethyl-1,3-butadiene, N,N-dimethylmethacrylamide), poly(n-butylmethacrylate), poly(cyclohexyl methacrylate), polyisobutyl methacrylate, poly(4-cyclohexylstyrene), polycyclol acrylate, polycyclol methacrylate, polydiethyl30 ethoxymethylenemalonate, poly(2,2,2-trifluoroethyl methacrylate), poly(1,1,1-trimethylolpropane trimethacrylate) polymethacrylate, poly(N, N-dimethylaniline, dihydrazide),poly(isophthalic di-hydrazine), isophthalic polyacid, polydimethyl benzilketal, epichlorohydrin,poly(ethyl-3,3-diethoxyacrylate), poly(ethyl-3,3-dimethylacrylate), poly(ethyl vinyl ketone), poly(vinyl ethyl ketone), poly(penten-3-one), poly-formaldehyde poly(diallyl acetal),polyfumaronitrile, polyglyceryl propoxy triacrylate, polyglyceryl trimethacrylate,polyglycidoxypropyltrimethoxysilane, polyglycidyl acrylate, poly(n-heptyl acrylate), poly(n-heptylacrylic acid ester), poly(n-heptyl methacrylate), poly(3-hydroxypropionitrile), poly(2-hydroxypropyl acrylate), poly(2-hydroxypropyl methacrylate) poly(N-(5 methacryloxyethyl)-phthalimide), poly(1,9-nonanediol diacrylate), poly(1,9-nonanediol dimethacrylate), poly(N-(n-propyl)acrylamide), poly(ortho-phthalic acid), poly(iso-phthalic acid), poly(1,4-benzenedicarboxylic acid), poly(1,3-benzenedicarboxylic acid), poly(phthalic acid),poly(mono-2-acryloxyethyl ester), terephthalic polyacid, phthalic polyanhydride polyethylene glycol diacrylate, polyethylene glycol methacrylate, polyethylene glycol dimethacrylate, polyisopropyl acrylate, polysorbitol pentaacrylate, polyvinyl bro-moacetate, polychloroprene, poly(di-n-hexylsilylene), poly(di-n-propylsiloxane), poly-dimethylsilylene, polydiphenyl siloxane, polyvinyl propionate, polyvinyl triace-toxysilane, polyvinyl tris-tert-butoxysilane, polyvinylbutyral, polyvinyl alcohol, polyvinyl acetate, polyethylene co-vinyl acetate, poly(bisphenol-A15polysulfone), poly(1,3-dioxepane), poly(1,3-dioxolane), poly(1,4-phenylene vinylene),poly(2,6-dimethyl-1A-phenylene oxide), poly(4-hydroxybenzoic acid), poly(4-methyl pentene-1), poly(4-vinylpyridine), polymethylacrylonitrile, poly-methylphenylsiloxane,polymethylsilmethylene, polymethylsilsesquioxane,poly(phenylsilsesquioxane),poly(pyromellitimide-1,4-diphenyl ether), polytetrahy-drofuran, polythiophene, poly(trimethylene oxide), polyacrylonitrile, polyether sulfone, polyethylene-co-vinyl acetate,poly(perfluoroethylene propylene), poly(perfluoroalkoxyl alkane), or poly(styreneacrylonitrile).

Preferred examples of polymers which can be used to produce the cross-linked shell include aliphatic epoxidized poly acrylates, e.g. soy bean oil acrylates, bisphenol Abased epoxy acrylates, glyceryl propoxy triacrylates, difunctional polyester acrylate oligomers, aliphatic polyester based urethane dimethacrylates or diacrylates and amine modified polyether acrylates. In that case the cross-linked shell comprises or consists of at least one of the aforesaid polymers.

The crosslinking agent may be selected from molecules bearing at least two functional groups selected from among the group constituted of the functions: acrylate, methacrylate, vinyl ether, N-vinyl ether, mercaptoester, thiolene, siloxane, epoxy, oxetane, urethane, isocyanate, and peroxide.

By way of example of crosslinking agent, mention may be made in particular of: diacrylates, such as 1,6-hexanediol diacrylate, 1,6-hexanediol dimethacrylate, polyethylene glycol dimethacrylate, 1,9-nonanediol dimethacrylate, 1,4-butanediol dimethacrylate, 2,2-bis(4-methacryloxyphenyl) propane, 1,3-butanediol dimethacrylate, 1,10-decanediol dimethacrylate, bis(2-methacryloxyethyl) N,N′-1,9-nonylene biscarbamate, 1,4-butanediol diacrylate, ethylene glycol diacrylate, 1,5-pentanediol dimethacrylate, 1,4-phenylene diacrylate, allyl methacrylate, N,N′-methylenebisacrylamide, 2,2-bis[4-(2-hydroxy-3-methacryloxypropoxy) phenyl]propane, tetraethylene glycol diacrylate, ethylene glycol dimethacrylate, di-ethylene glycol diacrylate, triethylene glycol diacrylate, triethylene glycol dimethacrylate, polyethylene glycol diglycidyl ether, N,N-diallylacrylamide, 2,2-bis[4-(2-acryloxyethoxy)phenyl]propane, glycidyl methacrylate; multifunctional acrylates such as dipentaerythritol pentaacrylate, 1,1,1-trimethylolpropane triacrylate, 1,1,1-trimethylolpropane trimethacrylate, ethylenediamine tetramethacrylate, pentaerythritol triacrylate, pentaerythritol tetraacrylate; acrylates also having other reactive functional groups, such as propargyl methacrylate, 2-cyanoethyl acrylate, tricy-clodecane dimethanol diacrylate, hydroxypropyl methacrylate, N-acryloxysuccinimide, N-(2-hydroxypropyl)methacrylamide, N-(3 aminopropyl)methacrylamide hy-drochloride, N-(t-BOC-aminopropyl)methacrylamide, 2-aminoethyl methacrylate hy-drochloride, monoacryloxyethyl phosphate, o-nitrobenzyl methacrylate, acrylic anhydride, 2-(tert-butylamino)ethyl methacrylate N,N-diallylacrylamide, glycidyl methacrylate, 2-hydroxyethyl acrylate, 2-hydroxybenzophenone, N-(Phthalimidomethyl)acrylamide, cinnamyl methacrylate.

In certain embodiments, the polymers described here before, which can be used to produce the cross-linked shell in the second aspect of the plurality of microcapsules according to the invention, can be used as additional components of the cross-linked shell in the first aspect of the plurality of microcapsules according to the invention. In that case, their content is generally less than 50% by weight relative to the total weight of the cross-linked polymeric shell. In that case, their content is generally equal to or greater than 20% by weight relative to the total weight of the cross-linked polymeric shell.

In a particular aspect of the plurality of microcapsules according the invention, the crosslinked polymeric shell is essentially free of nitrile functional groups. «Essentially free of nitrile functional groups» is understood to denote in particular a content of nitrile functional groups lower than 1 weight %, preferably less than 0.5 weight % relative to the total weight of the cross-linked polymeric shell. Preferably, the cross-linked polymeric shell is free of nitrile functional groups. This is in particular the case when no nitriles have been used as monomers, polymers or cross-linking agents for the production of the cross-linked polymeric shell.

The reactive agent may be released through a specific external stimulus, including but not limited to a change in pH, exposure to ultra-violet radiation, a change in temperature, and/or any combination thereof. In order to achieve said release by external stimulus, certain components of the shell may be selected, as disclosed in for instance EP 3548529.

In the plurality of microcapsules according to the invention, the shell encapsulates an active ingredient. The active ingredient can be a solid at 25° C. The active ingredient can also be a liquid at 25° C. and 1013.25 kPa pressure.

The plurality of microcapsules according to this aspect are obtainable, for example by a, preferably continuous, process which comprises (a) providing a double emulsion comprising droplets of at least one active ingredient (C1) dispersed in a photopolymerizable composition C2, said droplets being dispersed in a composition C3, the compositions C2 and C3 being immiscible with each other; (b) inducing a controlled shear rate in said double emulsion to provide a mixed double emulsion (C4); and (c) ir-radiating the mixed double emulsion (C4) to prepare the microcapsules.

In that aspect, the active ingredient is often selected from a catalyst, a UV absorber, a lubricant and a flame retardant, a pigment and a liquid crystal material. The procedure for the preparation of the double emulsion is disclosed in particular in EP 3548529,US-A-2020129948 and US-A-2021113984 in the name of the applicant, the contents of which are incorporated by reference into the present patent application.

In the plurality of microcapsules according to the invention the active ingredient can be suitably selected from, for example: a crosslinking agent, a hardener, an organic or metal catalyst (such as an organometallic or inorganometallic complex of platinum, palladium, titanium, molybdenum, copper, zinc) used for polymerising polymer-, elastomer-, rubber-, paint-, adhesive-, sealant-, mortar-, varnish-, or coating formulations;
a dye or pigment intended for elastomer-, paint-, coating-, adhesive-, sealant-, mortar-, or paper formulations
a fragrance (in accordance with the list of molecules established by the International Fragrance Association (IFRA) and available on the website www.ifraorg.org) intended for detersive products such as cleaning/washing products, home care products, cosmetic and personal care products, textiles, paints, coatings;
an aroma/flavouring agent, a vitamin, an amino acid, a protein, a lipid, a probiotic, an antioxidant, a pH corrector, a preservative for food compounds and animal feed;
a softener, a conditioning agent for detersive products, cleaning/washing products, cosmetics and personal care products. In this regard, the active agents that may be used are for example as listed in the US patents U.S. Pat. Nos. 6,335,315 and 5,877,145;
an anti-discolouration or anti-fading agent (such as an ammonium derivative), an antifoaming agent (such as an alcohol ethoxylate, an alkylbenzene sulfonate, a polyethylene ethoxylate, an alkylethoxysulfate or alkylsulfate) intended for detersive products and cleaning/washing products and home care products;
a brightening agent, also referred to as a colour activating agent (such as a stilbene derivative, a coumarin derivative, a pyrazoline derivative, a benzoxazole derivative, or a naphthalimide derivative) intended for detersive products, cleaning/washing products, cosmetics and personal care products;
a biologically active compound such as an enzyme, a vitamin, a protein, a plant extract, an emollient agent, a disinfecting agent, an antibacterial agent, an anti-UV agent, a medicament intended for cosmetic and personal care products, and textiles. Among these biologically active compounds the following may be mentioned: vitamins A, B, C, D and E, para-aminobenzoic acid, alpha hydroxy acids (such as glycolic acid, lactic acid, malic acid, tartaric acid, or citric acid), camphor, ceramides, polyphenols (such as flavonoids, phenolic acid, ellagic acid, tocopherol, ubiquinol), hydroquinone, hyaluronic acid, isopropyl isostearate, isopropyl palmitate, oxybenzone, panthenol, proline, retinol, retinyl palmitate, salicylic acid, sorbic acid, sorbitol, triclosan, tyrosine;
a disinfecting agent, an antibacterial agent, an anti-UV agent, intended for paints and coatings;
an agrochemical product such as for example a fertiliser, a herbicide, an insecticide, a pesticide, a fungicide, a repellent, or a disinfecting agent intended for agrochemical products;
a fire resistant agent, also known as a flame retarding agent, (for example a brominated polyol such as tetrabromobisphenol A, a halogenated or non-halogenated organophosphorus compound, a chlorinated compound, an aluminum trihydrate, an antimony oxide, a zinc borate, a red phosphorus, a melamine, or a magnesium di-hydroxide) intended for use in plastic materials, coatings, paints, and textiles;
a photonic crystal or a photochromophore intended for use in paints, coatings, and in polymer materials that form curved and flexible screens;
a product known to the person skilled in the art under the accepted nomenclature Phase Change Materials (PCMs) that is capable of absorbing or releasing so-called ‘latent’ heat when going through a change in a phase, intended for the storage of energy. Examples of PCMs and the applications thereof are described in “A review on phase change energy storage: materials and applications”, Farid et al., Energy Conversion and Management, 2004, 45(9-10), 1597-1615. By way of examples of PCMs, mention may be made of molten salts of aluminum phosphate, ammonium carbonate, ammonium chloride, cesium carbonate, cesium sulfate, calcium citrate, calcium chloride, calcium hydroxide, calcium oxide, calcium phosphate, calcium saccharate, calcium sulfate, cerium phosphate, iron phosphate, lithium carbonate, lithium sulfate, magnesium chloride, magnesium sulfate, manganese chloride, manganese nitrate, manganese sulfate, potassium acetate, potassium carbonate, potassium chloride, potassium phosphate, rubidium carbonate, rubidium sulfate, disodium tetraborate, sodium acetate, sodium bicarbonate, sodium bisulfate, sodium citrate, sodium chloride, sodium hydroxide, sodium nitrate, sodium percarbonate, sodium persulfate, sodium phosphate, sodium propionate, sodium selenite, sodium silicate, sodium sulfate, sodium tellurate, sodium thiosulfate, strontium hy-drophosphate, zinc acetate, zinc chloride, sodium thiosulfate, paraffinic hydrocarbon waxes, polyethylene glycols.

In one embodiment of the plurality of microcapsules according to the invention, the active ingredient does not consist of a foaming agent. In this embodiment, the active ingredient does often not comprise a foaming agent. Generally, the microcapsules in the plurality of microcapsules according to the invention of this embodiment are not expandable.

In a particular embodiment of the preferred aspect of the plurality of microcapsules according to the invention, the active ingredient is a lubricant. Examples of suitable lubricants include but are not limited to oils such as mineral oils, polyalphaolefins, polyglycols, synthetic esters, phosphate esters, triglyceride esters, polyol esters, fatty acids, vegetal oils, silicone oils, polyethers, perfluoropolyethers, as well as solid lubricants, such as notably amides, such as erucamide or ethylene bis(stearamide), and synthetic or natural waxes (paraffins).

It has been found that the plurality of microcapsules of this particular embodiment are particularly advantageous to enhance the wear resistance or the scratch or the water resistance of a polymeric surface.

The invention consequently also concerns the use of the plurality of microcapsules according to this particular embodiment to enhance the wear resistance or the scratch resistance of a polymeric surface and the use of the plurality of microcapsules according to this particular embodiment to enhance the water resistance of a polymeric surface. Such polymeric surfaces include for example an epoxy-resin surface or an acrylic resin surface. Such surfaces may further be applied to objects such as e.g coatings, textiles and gaskets.

The invention consequently also concerns the use of the plurality of microcapsules according to this particular embodiment for the self-lubrication of an elastomer. Preferably, the lubricant is a polyol ester.

It has been found that the composition of elastomer and plurality of microcapsules according to the invention keeps storage and processing advantage while adequately releasing the lubricant when exposed to high shear stress over a long duration.

The invention also concerns the use of the plurality of microcapsules according to the invention, for the supply of an active ingredient to a polymerization process or to a polymer processing process.

It has been found that the plurality of microcapsules according to the invention and in particular according preferred aspect is particularly advantageous to protect active ingredients such as catalysts under the, sometimes severe, conditions of mechanical stress and temperature encountered. In the aspect wherein the microcapsules include air or a gas, the plurality of microcapsules allows for an efficient and stable reduction of the density of the produced polymer.

The use according to the invention may be for example, for the production of a thermoset polymer. It may also be for the production of a molded, extruded or cast thermoplastic article or thermoset article. It may also be for the production of a compression molded or an injection molded thermoplastic article or thermoset article.

The invention also concerns a premix for manufacturing a thermoset polymer, comprising the plurality of microcapsules according to the invention. The premix according to the invention preferably comprises an epoxy resin which is combined with the plurality of microcapsules according to the invention containing an anionic or cationic catalyst as the active ingredient. Another embodiment may be a premix in the form of acrylic resins, vinyl resins and polyesters which are combined with the plurality of microcapsules according to the invention containing an unsaturated monomer diluent such as: acrylic acid, acrylamide, acryloyl chloride, and methyl methacrylate as the active ingredient.

In another embodiment, the premix according to the invention comprises an isocyanate resin which is combined with the plurality of microcapsules according to the invention containing at least a polyol as the active ingredient.

It has been found that the storage and process stability of the premix according to the invention is improved. The premix according to the invention is capable of surviving extreme conditions to which the premix may be exposed during standard processing conditions, such as extrusion and/or injection molding.

In a particular aspect, the premix according to the invention comprises an epoxy resin and the plurality of microcapsules according to the invention wherein the active ingredient is a latent accelerator of curing of the epoxy resin. Suitable latent accelerators may be selected, for example, from amine latent accelerators, in particular polyamine latent accelerators. Particular examples are selected from modified polyamines, e.g. Ancamine2014 FG.

The invention also concerns a mixture comprising a thermoplastic polymer and the plurality of microcapsules according to the invention. Examples of thermoplastic polymers which can be used in the mixture according to the invention include but are not limited to polyolefins such as for example polyethylene and polypropylene, polyvinyl chloride, polystyrene, polyamides and polyesters.

The invention also concerns a polymer composition comprising a plurality of microcapsules according to the invention.

It is still another object of the invention to provide a method for determining the mechanical resistance of a plurality of microcapsules having a core and a polymeric shell which comprises (a) providing a dispersion of the plurality of microcapsules in an inert medium (b) submitting the dispersion to a determined shear stress at a defined temperature for a defined time (c) determining by optical analysis the rate of broken capsules after step (b).

In the method according to the invention, the inert medium is generally a transparent and viscous liquid at the temperature of step (b). The inert medium is furthermore stable in its viscosity as a function of shear.

Preferably, the dispersion is submitted to the determined shear stress using a three-roll mill.

A preferred method is method (1) described in the example below.

Further details of the method according to the invention are described above in the context of the plurality of microcapsules according to the invention.

To the extent that there would be a conflict or inconsistency between any document incorporated by reference and the present description, the present description shall take precedence.

The examples here after are intended to illustrate the invention without however limiting it.

### EXAMPLES

### Method (1)

### Sample Preparation

(a) Water resistant microcapsules: 10-50 g of capsules are dispersed at a concentration of 5% in an aqueous solution of 14% of carboxymethyl cellulose in deionized water. The dispersion is gently shaken to ensure that the concentration of microcapsules is homogeneous in the sample.

(b) Water sensitive microcapsules: 10-50 g of microcapsules are dispersed in silicone oil (such as Priolube 3986) at a concentration of 5% The dispersion is gently shaken to ensure that the concentration of microcapsules is homogeneous in the sample.

Silicon oil can also be used as a medium for the measurement of water resistant capsules and may present certain advantages in the rheological properties of the solution thereof with microcapsules, such as the stability of the viscosity over the course of the application of a shear by a three-roll mills process.

The temperature of the sample obtained according to protocol (a) or (b) is checked and adjusted, if appropriate to 20° C. The sample is poured into a funnel feeding the first gap of an Exakt three roll mill which is operated at a temperature of 20° C.+−2° C. The operating conditions of the mill are tuned to impart the desired shear stress for up to 30 minutes, but preferably 10 minutes. The gap between the mills is greater than 30 microns, preferably greater than 50 microns and preferably greater than 100 microns, but below 1 cm.

At the outlet of the mill, a drop of the dispersion containing at least 100 microcapsules, preferably 150 microcapsules, is examined within 30 minutes by optical microscopy using a DMi8 microscope (from Leica) operating in transmission light mode equipped with a HCX Plan Apo 100×/1.4-0.7 objective. The total number of capsules examined and the number of broken capsules is determined and the percentage of broken capsules is calculated.

### Examples 1 to 6—Preparation of a Plurality of Microcapsules According to the Invention

### Example 1—Preparation of Double Emulsion According to US2021113984

### Step a): Creation of the Core of the Capsules (Dispersion of Particles—Composition C1b)

TABLE 1

| Weight | (g) | % |
|---|---|---|
| Composition C1a | | |
| Solvesso 200 ND | 14 | 40 |
| Saturated triglyceride wax | 6 | 17.1 |
| (Suppocire DM wax, | | |
| Gattefoss e) | | |
| Composition B | | |
| Dispersant (Tween 80, | 2 | 5.7 |
| Sigma Aldrich) | | |
| Deionized water | 13 | 37.2 |
| Total | 35 | 100 |

The composition C1a is placed in a bath thermostated at 350° C. and stirred at 500 rpm until complete dissolution of the wax. Composition B is placed in a bath thermostated at 35° C. and stirred at 200 rpm until complete homogenization. The composition Cla is then added to the composition B dropwise under stirring at 2000 rpm, still at 35° C. The mixture is stirred at 2000 rpm for 5 minutes and then sonicated (Vibra-cell 75042, Sonics) for 20 minutes (pulse 5s/2s) at 30% amplitude. If the temperature exceeds 35° C. during sonication, the mixture is cooled by ice.

After cooling, 1.05 g of modified polyethylene glycol gelling agent (Aculyn 44N, Dow) is added to the mixture under stirring at 500 rpm until gelation. The composition C1b is thus obtained.

TABLE 2

| Components | Weight (g) | % Total |
|---|---|---|
| Composition C1b | 3 | 30 |
| Composition C2 | 7 | 70 |
| CN981 (urethane acrylate | 6.09 | |
| oligomer, Sartomer) | | |
| HDDA (hexane-1,6-diol di- | 0.7 | |
| acrylate, Sartomer) | | |
| Darocur 1173 | 0.21 | |
| (photoinitiator, BASF) | | |
| Total | 10 | 100 |

The composition C1 is added dropwise to the composition C2 under stirring at 2000 rpm, at a temperature T

### Step c): Preparation of the Second Emulsion (E2)

TABLE 3

| | | Weight (g) | % total |
|---|---|---|---|
| First emulsion (E1) | | 5 | 5 |
| Composition C3 | Modified | 2.85 | 2.85 |
| | polyethylene glycol | | |
| | gelling agent | | |
| | (Aculyn 44N, Dow) | | |
| | Deionized water | 92.15 | 92.15 |
| | Total | 100 | 100 |

The composition C3 is stirred at 1000 rpm until complete homogenization. The first emulsion (E1) is then added dropwise to the composition C3 under stirring at 1200 rpm, at a temperature T

### Step d): Refining in Size of the Second Emulsion

The second polydisperse emulsion obtained in the preceding step is stirred at 1200 rpm for 10 minutes, at a temperature Td=20° C. A monodisperse emulsion (E3) is thus obtained.

### Example 2—Photopolymerization

A volume of 3000 mL of double emulsion E3 is prepared as described in example 1 here before. A quartz flask having a useful volume of 1000 mL, equipped with a feed line, a withdrawal line and a stirring device, imparting a shear rate of 70s′ is filled with double emulsion E3 obtained as described here before, having a transmittance of 0.9 and a viscosity of 5 000 mP/s. Stirring is initiated to provide a mixed double emulsion E4 and a UV lamp emitting at 365 nm having a maximum light intensity of 1 W/cm2 arranged perpendicularly to a wall of the flask is turned on. A flow of 300 mL/min of mixed polymerized double emulsion is continuously withdrawn through the withdrawal line while fresh double emulsion is fed through the feed line at the same rate.

The obtained microcapsules are monodisperse. Substantially no coalescence of droplets is observed. The conversion of reactive groups is at least 80%

A sample taken from the plurality of microcapsules is tested using method (1)protocol (a) (water-resistant) at a shear stress 3 kPa. The percentage of broken capsules is less than 10%; Method (1) protocol (a) (water-resistant) is repeated at a shear stress of more than 6 kPa; The percentage of broken capsules is less than 10%;

### Example 2a

The process of example 2 is carried out but in addition the mixed double emulsion withdrawn is allowed to flow through a quartz tube having a diameter of 5 cm irradiated by a second UV lamp emitting at 365 nm having a maximum light intensity of 1 W/cm2.

The obtained microcapsules are monodisperse. Substantially no coalescence of droplets is observed. The conversion of reactive groups is at least 90%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%;

### Example 2b

The process of example 2 is carried out but in addition the flask is equipped with a recycle line whereby 50% of the stream withdrawn is recycled. The feed rate of double emulsion E3 is adjusted correspondingly.

The obtained microcapsules are monodisperse. Substantially no coalescence of droplets is observed.

The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%;

### Example 2c

The double emulsion E3 is continuously introduced at a rate of ml/min into a tube equipped with a static mixer imparting a shear rate of 70s¹. The Reynolds number is 0.1. The mixed double emulsion is then fed at a rate of 300 ml/min into the feed line of the flask and the irradiation is carried out as described in example 2.

The obtained microcapsules are monodisperse. Substantially no coalescence of droplets is observed.

The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa The percentage of broken capsules is less than 10%;

### Example 2d

The process of Example 2c is carried out but the mixed double emulsion is irradiated in a quartz tube in accordance with example 2a instead of the flask.

The obtained microcapsules are monodisperse. Substantially no coalescence of droplets is observed.

The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%;

### Comparative Example 1

200 ml of the double emulsion (E3) obtained in example 1 is poured into a 500 ml beaker and irradiated for 15 minutes with the aid of a UV light source (Dymax LightBox ECE 2000) having a maximum light intensity of 1 W/cm² at a waveform length of 365 nm.

The obtained microcapsules are substantially monodisperse but some coalescence of droplets is observed. The conversion of reactive groups is below 75%.

A sample taken from the plurality of microcapsules is tested using method (1)protocol (a) (water-resistant) at a shear stress of more than 3 kPa. The percentage of broken capsules is greater than 10% but less than 15%; Method (1) protocol (a) (water-resistant) is repeated at a shear stress of more than 6 kPa; The percentage of broken capsules is greater than 10% but less than 15%

### Example 3

### Preparation of a Double Emulsion According to US2020129948)

Step a): Preparation of the first emulsion (E1)

TABLE 4

| | Raw Materials | % in C2 | % in E1 |
|---|---|---|---|
| Composition C1 | Paraffin oil | | 30 |
| Composition C2 | CN 1963 (aliphatic urethane | 80 | 70 |
| | acrylate, Sartomer) | | |
| | SR 399 (polymerizing agent, | 17 | |
| | dipentaerythritol | | |
| | pentacrylate, Sartomer) | | |
| | Darocur 1173 (photoinitiator, | 3 | |
| | BASF) | | |

| | | |
|---|---|---|
| Total | 100 | 100 |

The composition C2 has the following characteristics:

CN component 1963 has 2 reactive acrylate functions per molecule and an average molecular weight of less than 5,000 g/mol.

The crosslinking agent SR 399 has 5 reactive acrylate functions per molecule and a molecular weight of 524.5 g/mol.

The Darocur 1173 photoinitiator has no reactive functions and its molecular weight is 164 g/mol. The composition C1 is added dropwise to the composition C 2 with stirring at 2000 rpm with a ratio of 3:7. The first emulsion (E1) is thus obtained. Step b): Preparation of the second emulsion (E2)

TABLE 5

| | Raw Materials | % |
|---|---|---|
| First Emulsion (E1) | | 5 |
| Composition C3 | Sodium Alginate | 9.5 |
| | (Sigma Aldrich) | |
| | Deionized water | 85.5 |

| | |
|---|---|
| Total | 100 |

The composition C3 is stirred at 1000 rpm until complete homogenization and then left to stand for one hour at room temperature. The first emulsion (E1) is then added dropwise to the composition C3 with stirring at 1000 rpm. This gives the second emulsion (E2).

Step c): Refining in size of the second emulsion The second polydisperse emulsion (E2) obtained in the previous step is stirred at 1000 rpm for 10 minutes. A monodisperse emulsion (E3) is thus obtained.

### Example 4—Photopolymerization

A volume of 3000 mL of double emulsion E3 is prepared as described in example 3 here before. A quartz flask having a useful volume of 1000 mL, equipped with a feed line, a withdrawal line and a stirring device, imparting a shear rate of 70s′ is filled with double emulsion E3 obtained as described here before, having a transmittance of 0.9 and a viscosity of 5 000 mPa*s. Stirring is initiated to provide a mixed double emulsion E4 and a UV lamp emitting at 365 nm having a maximum light intensity of 1 W/cm2 arranged perpendicularly to a wall of the flask is turned on. A flow of 300 mL/min of mixed polymerized double emulsion is continuously withdrawn through the withdrawal line while fresh double emulsion is fed through the feed line at the same rate.

The obtained microcapsules are monodisperse. Substantially no coalescence of droplets is observed. The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%;

### Example 4a

The process of example 4 is carried out but in addition the mixed double emulsion withdrawn is allowed to flow through a quartz tube having a diameter of 5 cm irradiated by a second UV lamp emitting at 365 nm having a maximum light intensity of 1 W/cm2, the quartz tube further comprising a rotostator mixer

The obtained microcapsules are monodisperse. Substantially no coalescence of droplets is observed.

The conversion of reactive groups is at least 90%

A sample taken from the plurality of microcapsules is tested using method (1)protocol (a) (water-resistant) at a shear stress of more than 3 kPa. The percentage of broken capsules is less than 5%; Method (1) protocol (a) (water-resistant) is repeated at a shear stress of more than 6 kPa; The percentage of broken capsules is less than 5%;

### Example 4b

The process of example 4 is carried out but in addition the flask is equipped with a recycle line whereby 50% of the stream withdrawn is recycled. The feed rate of double emulsion E3 is adjusted correspondingly.

The obtained microcapsules are monodisperse. Substantially no coalescence of droplets is observed.

The conversion of reactive groups is at least 80%

A sample taken from the plurality of microcapsules is tested using method (1)protocol (a) (water-resistant) at a shear stress of more than 3 kPa. The percentage of broken capsules is less than 5%; Method (1) protocol (a) (water-resistant) is repeated at a shear stress of more than 6 kPa; The percentage of broken capsules is less than 5%;

### Example 4c

The double emulsion E3 is continuously introduced at a rate of ml/min into a tube equipped with a static mixer imparting a shear stress rate of 70s-1. The Reynolds number is 0.1. The mixed double emulsion is then fed at a rate of 300 ml/min into the feed line of the flask and the irradiation is carried out as described in example 2.

The obtained microcapsules are monodisperse. Substantially no coalescence of droplets is observed.

The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%.

### Example 4d

The process of Example 2c is carried out but the mixed double emulsion is irradiated in a quartz tube in accordance with example 2a instead of the flask.

The obtained microcapsules are monodisperse. Substantially no coalescence of droplets is observed.

The conversion of reactive groups is.at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa:he percentage of broken capsules is less than 10%.

### Comparative Example 2

200 ml of the double emulsion (E3) obtained in example 1 is poured into a 500 ml beaker and irradiated for 15 minutes with the aid of a UV light source (Dymax LightBox ECE 2000) having a maximum light intensity of 1 W/cm2 at a waveform length of 365 nm.

The obtained microcapsules are substantially monodisperse but some coalescence of droplets is observed. The conversion of reactive groups is below 75%.

A sample taken from the plurality of microcapsules is tested using method (1)protocol (a) (water-resistant) at a shear stress of more than 3 kPa. The percentage of broken capsules is less than 15%; Method (1) protocol (a) (water-resistant) is repeated at a shear stress of more than 6 kPa; The percentage of broken capsules is greater than 10% but less than 15%;

### Example 5

### Preparation of a Double Emulsion According to US2020129948)

### Step a): Preparation of the First Emulsion (E1)

TABLE 6

| | Raw Materials | % in C2 | % in E1 |
|---|---|---|---|
| Composition C1 | Silicon oil | | 40 |
| Composition C2 | CN 111 (epoxydized soy | 85 | 60 |
| | bean oil acrylate, Sartomer) | | |
| | SR 238 (hexanediol di- | 10 | |
| | acrylate, Sartomer) | | |
| | Darocur 1173 | 5 | |
| | (photoinitiator, BASF) | | |

| | | |
|---|---|---|
| Total | 100 | 100 |

The composition C2 has the following characteristics:

CN component 111 has 5 reactive acrylate functions per molecule and an average molecular weight of less than 2300 g/mol.

The crosslinking agent SR 238 has 2 reactive acrylate functions per molecule and a molecular weight of 226 g/mol.

The composition C1 is added to the composition C2 while stirring at 200 rpm with a mechanical stirrer (IKA 2000) equipped with a stirring anchor. The first emulsion (E1) is thus obtained.

### Step b): Preparation of the Second Emulsion (E2)

TABLE 7

| | Raw Materials | % |
|---|---|---|
| First Emulsion (E1) | | 10 |
| Composition C3 | Cellulose derivative | 7.2 |
| | (Roeper) | |
| | Deionized water | 82.8 |

| | |
|---|---|
| Total | 100 |

The composition C3 is stirred at 2000 rpm until complete homogenization and then left to stand for one hour at room temperature. The first emulsion (E1) is then added one time to the composition C3 whilestirring at 2000 rpm with a mechanical stirrer (IKA 2000) equipped with a 3 cm diameter deflocculating stirring propeller. This gives the second emulsion (E2).

Step c): Refining in size of the second emulsion The second polydisperse emulsion (E2) obtained in the previous step is stirred at 2000 rpm for 2 minutes. A monodisperse emulsion (E3) is thus obtained.

Step d): A volume of 3000 mL of double emulsion E3 is prepared as described in example 3 here before. A quartz flask having a useful volume of 1000 mL, equipped with a feed line, a withdrawal line and a stirring device, imparting a shear rate of 70s0,is filled with double emulsion E3 obtained as described here before, having a transmittance of 0.9 and a viscosity of 5000 mPa*s. Stirring is initiated to provide a mixed double emulsion E4 and a UV lamp emitting at 365 nm having a maximum light intensity of 1 W/cm² arranged perpendicularly to a wall of the flask is turned on. A flow of 300 mL/min of mixed polymerized double emulsion is continuously withdrawn through the withdrawal line while fresh double emulsion is fed through the feed line at the same rate.

The obtained microcapsules are monodisperse. Substantially no coalescence of droplets is observed. The conversion of reactive groups is at least 80%.

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%;

### Example 6

CN104D80—bisphenol A epoxy acrylate 75%, 20% SR238, 5% Darocur 1173

### Preparation of a Double Emulsion According to US2020129948)

### Step a): Preparation of the First Emulsion (E1)

TABLE 8

| | Raw Materials | % in C2 | % in E1 |
|---|---|---|---|
| Composition C1 | Silicon oil | | 40 |
| Composition C2 | CN 104D80 (80% di- | 75 | 60 |
| | functional bisphenol A based | | |
| | epoxy acrylate with 20% of | | |
| | glyceryl, propoxy triacrylate, | | |
| | Sartomer) | | |
| | SR 238 (hexanediol di- | 20 | |
| | acrylate, Sartomer) | | |
| | Darocur 1173 | 5 | |
| | (photoinitiator, BASF) | | |

| | | |
|---|---|---|
| Total | 100 | 100 |

The composition C2 has the following characteristics: PGP29JI

CN component 104D80 has 2 reactive acrylate functions per molecule of bisphenol A epoxy acrylate and 3 reactive functions per molecule of glycerol, propoxylated, esters with acrylic acid and an average molecular weight of less 750 g/mol.

The crosslinking agent SR 238 has 2 reactive acrylate functions per molecule and a molecular weight of 226 g/mol.

The composition C1 is added in 5 min to the composition C 2 with stirring at 200 rpm with a mechanical stirrer (IKA 2000) equipped with a stirring anchor. The first emulsion (E1) is thus obtained. Step b): Preparation of the second emulsion (E2)

TABLE 9

| | Raw Materials | % |
|---|---|---|
| First Emulsion (E1) | | 10 |
| Composition C3 | Cellulose derivative | 7.2 |
| | (Roeper) | |
| | Deionized water | 82.8 |

| | |
|---|---|
| Total | 100 |

The composition C3 is stirred at 2000 rpm until complete homogenization and then left to stand for one hour at room temperature. The first emulsion (E1) is then added one time to the composition C3 with stirring at 2000 rpm with a mechanical stirrer (IKA 2000) equipped with a 3 cm diameter deflocculating stirring propeller. This gives the second emulsion (E2).

Step c): Refining in size of the second emulsion The second polydisperse emulsion (E2) obtained in the previous step is stirred at 2000 rpm for 2 minutes. A monodisperse emulsion (E3) is thus obtained.

### Step d):

A volume of 3000 mL of double emulsion E3 is prepared as described in example 3 here before. A quartz flask having a useful volume of 1000 mL, equipped with a feed line, a withdrawal line and a stirring device, imparting a shear rate of 70s-1, is filled with double emulsion E3 obtained as described here before, having a transmittance of 0.9 and a viscosity of 5 000 mPa*s. Stirring is initiated to provide a mixed double emulsion E4 and a UV lamp emitting at 365 nm having a maximum light intensity of 1 W/cm2 arranged perpendicularly to a wall of the flask is turned on. A flow of 300 mL/min of mixed polymerized double emulsion is continuously withdrawn through the withdrawal line while fresh double emulsion is fed through the feed line at the same rate. The obtained microcapsules are monodisperse. Substantially no coalescence of droplets is observed. The conversion of reactive groups is at least 80%

A sample taken from the plurality of microcapsules is tested using method (1)protocol (a) (water-resistant) at a shear stress of more than 3 kPa. The percentage of broken capsules is less than 10%; Method (1) protocol (a) (water-resistant) is repeated at a shear stress of more than 6 kPa; The percentage of broken capsules is less than 10%.

1-109. (canceled)

110. A plurality of microcapsules having a cross-linked polymeric shell encapsulating an active ingredient, wherein the crosslinked polymeric shell comprises at least one polymer selected from the group of aliphatic epoxidized poly acrylates consisting of soybean oil acrylates, bisphenol A based epoxy acrylates, glyceryl propoxy triacrylates, difunctional polyester acrylate oligomers, and amine modified polyether acrylates.

111. The plurality of microcapsules according to claim 110, wherein the crosslinked polymeric shell comprises from 50% per weight to 80% per weight relative to the total weight of the crosslinked polymeric shell of said at least one polymer.

112. The plurality of microcapsules according to claim 110, wherein the cross-linked polymeric shell has a degree of cross-linking determined by observation of the reduction of FTIR absorption of a characteristic FTIR absorption band of a cross-linkable precursor group of the cross-linked polymeric shell which is equal to or greater than 80%.

113. The plurality of microcapsules according to claim 112, wherein the cross-linkable precursor group is selected from an acrylate and a methacrylate group.

114. The plurality of microcapsules according to claim 110, wherein the microcapsules have an average diameter of from 1 to 30 μm and a wall thickness from 0.1 to 20 μm.

115. The plurality of microcapsules according to claim 110, wherein the active ingredient is a solid at 25° C.

116. The plurality of microcapsules according to claim 110, wherein the active ingredient encapsulated in the microcapsules is a latent accelerator of curing of an epoxy resin.

117. The plurality of microcapsules according to claim 110, wherein the active ingredient is selected from oils and solid lubricants.

118. A polymer composition comprising the plurality of microcapsules according to claim 110.

119. The polymer composition according to claim 118, wherein the polymer is a thermoplastic polymer.

120. The polymer composition according to claim 119, wherein the thermoplastic polymer is selected from polyethylene and polypropylene, polyvinyl chloride, polystyrene, polyamides and polyesters.

121. The polymer composition according to claim 118, wherein the polymer is a thermoset polymer.

122. The polymer composition according to claim 118, wherein the polymer is an elastomer.

123. The polymer composition according to claim 118, which comprises from 0.5 wt % to 20 wt % of the plurality of microcapsules and from 80 wt % to 99.5 wt % of the polymer, relative to the total weight of the polymer composition.

124. A premix for manufacturing a thermoset polymer, comprising the plurality of microcapsules according to claim 110.

125. The premix according to claim 124, which comprises an epoxy resin.

126. The plurality of microcapsules according to claim 112, wherein the degree of cross-linking is equal to or greater than 90%.

127. The plurality of microcapsules according to claim 110, wherein the rupture stress of said plurality of microcapsules determined using an Anton Paar NHT3 nanoindentor with a flat punch indentor having a plate-like geometry with a diameter of 20 μm, is greater than 0.5 MPa.

128. The plurality of microcapsules according to claim 127, wherein the rupture stress of said plurality of microcapsules determined using an Anton Paar NHT3 nanoindentor with a flat punch indentor having a plate-like geometry with a diameter of 20 μm, is greater than 3 MPa.

129. The plurality of microcapsules according to claim 110, wherein the active ingredient is selected from mineral oils, polyalphaolefins, polyglycols, synthetic esters, phosphate esters, triglyceride esters, polyol esters, fatty acids, vegetal oils, silicone oils, polyethers, perfluoropolyethers, amides, and synthetic or natural waxes.
